(19) United States
(12) Patent Application Publication
(10) Pub. No.: US 2008/0068286 A1
(43) Pub. Date: Mar. 20, 2008

(54) MONITOR WITH SPECTRUM PANEL

(75) Inventors: WEN-WU WANG, Shenzhen (CN); SHIH-FANG WONG, Tu-Cheng (TW); TSUNG-JEN CHUANG, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/857,454

(22) Filed: Sep. 19, 2007

(30) Foreign Application Priority Data
Sep. 20, 2006 (CN) 200610062673.5

(51) Int. Cl. G09G 5/00

(52) U.S. Cl. 345/1.1

(57) ABSTRACT

A monitor with a spectrum panel is provided. The monitor includes: a micro controller unit (MCU) connecting with an audio module, a spectrum module. The spectrum module is connected with a spectrum switch and a spectrum panel. The audio module converts audio data from a computer into sound. The spectrum module converts the audio data into spectral images. The spectrum panel is used for displaying the spectral images. The spectrum switch is used for activating and deactivating the spectrum module and the spectrum panel. The spectrum panel will continue to provide visual information of a song to a user even when the display is off.

### BACKGROUND

1. Technical Field

The present invention relates to computer monitors, particularly to a computer monitor with a spectrum panel.

2. Related Art

Nowadays, it is common for computer monitors to have built-in speakers in the frame of the monitors. Built-in speakers are convenient to the user because it saves desk space, does not need a separate power cord, and does not need to be carried separately from the monitor. Usually when a user listens to music, he may want to observe the beat or pitch of the music through an on-screen visualization application, such as Windows media player or Winamp media player. However, when the user wants to only play music on his computer he usually turn off the monitor for power saving. However, if the monitor is turned off, the visualization application will not be displayed.

Accordingly, it would be advantageous to have a monitor configured with an independently visualization or spectrum panel in its frame. When the user turns off the monitor for power saving, the visualization or spectrum (hereinafter spectrum) panel will continue to provide the visual information of the music to the user.

### SUMMARY

A monitor with a spectrum panel is provided in accordance the present preferred embodiment. The monitor includes: a micro controller unit (MCU), an audio module connected to the MCU, and a spectrum module. The spectrum module is connected with a spectrum switch and a spectrum panel. The audio module converts audio data from a computer into sound. The spectrum module converts the audio data into spectral images. The spectrum panel is used for displaying the spectral images. The spectrum switch is used for activating and deactivating the spectrum module and the spectrum panel.

### BRIEF DESCRIPTION OF THE DRAWINGS

FIG. 1 shows a monitor with a spectrum panel according to a preferred embodiment of the present invention;

FIG. 2 is a block diagram of hardware infrastructure of the monitor in accordance with the preferred embodiment; and

FIG. 3 describes a flow chart of a preferred method for controlling the spectrum panel according to the present invention.

### DETAILED DESCRIPTION OF THE EMBODIMENTS

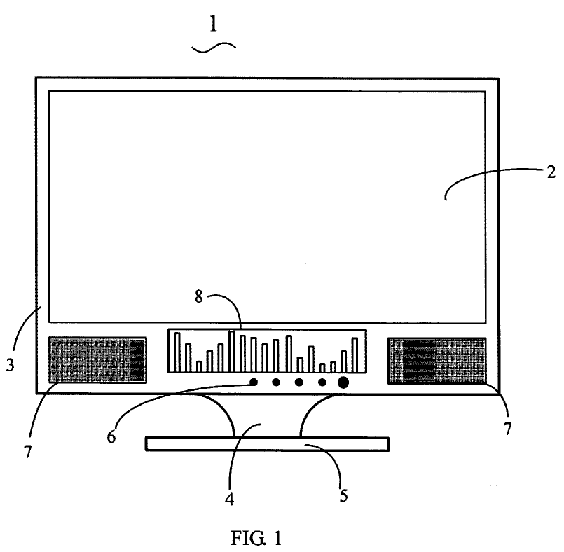

FIG. 1 shows a monitor with a spectrum panel according to a preferred embodiment of the present invention. The monitor 1 includes a display screen 2 for displaying images, a frame 3 around the display screen 2 for protecting the display screen 2, a support member 4, and a base 5. The monitor 1 further includes a spectrum switch 6, a speaker 7, and a spectrum panel 8. The spectrum switch 6 is for receiving input related to the spectrum panel 8. The spectrum panel 8 is for displaying spectral images. The spectrum panel 8 can be used independently of the screen 2, that is, the screen can be turned off and the spectrum panel 8 can be used to display spectral images of an audio file.

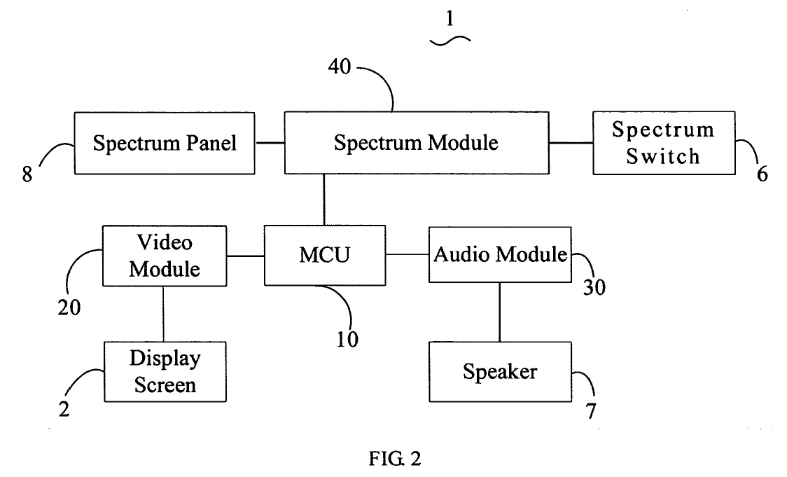

FIG. 2 is a block diagram of hardware infrastructure of the monitor 1 in accordance with the preferred embodiment. The monitor 1 includes a microcontroller unit (MCU) 10, a video module 20, an audio module 30, a spectrum module 40, the display screen 2, the speaker 7, and the spectrum panel 8. The video module 20 is used to convert the video data inputted from a computer (not shown) into images shown on the display screen 2. The audio module 30 is used to convert the audio data inputted from the computer into sound broadcasted by the speaker 7. The spectrum module 40 is used to convert the audio data inputted from the computer into spectral images.

The MCU 10 is connected with the video module 20, the audio module 30, and the spectrum module 40, and is configured for controlling the modules. The spectrum switch 6 is connected to the spectrum module 40 and is configured for activating or deactivating the spectrum module 40. The spectrum panel 8 is connected to the spectrum module 40 for displaying the spectrum images.

When the spectrum switch 6 is turned on, the spectrum module 40 becomes activated to convert the audio data into spectral images for displaying on the spectrum panel 8. When the spectrum switch 6 is turned off, the spectrum module 40 becomes inactivated and no spectral image is displayed. The spectrum module 40 and the spectrum panel 8 are independent of the display screen 2. That is, operations of the spectrum module 40 and operations of the spectrum panel 8 are independent from operations of the display screen 2. Therefore, when the user want to play a song and get the information of the song played at present, he only need to actuate the spectrum panel 8 while the display screen 2 can be turned off for power saving.

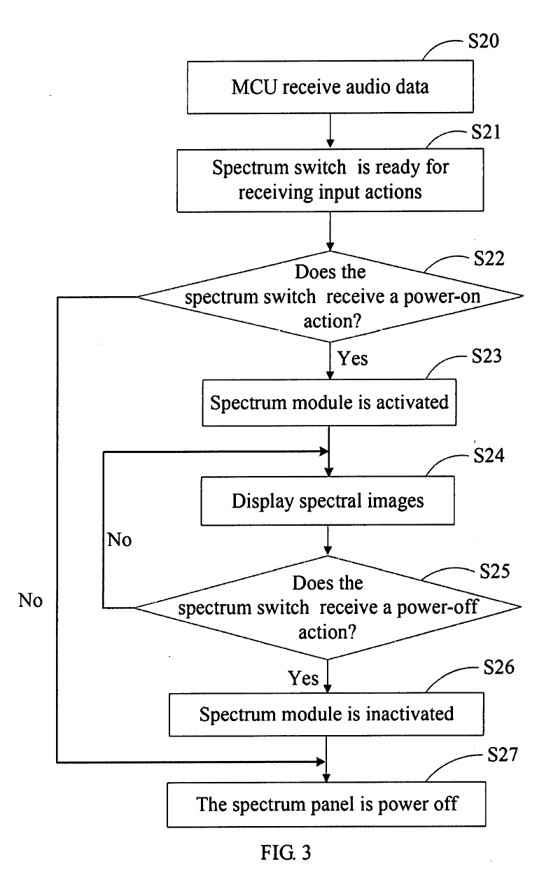

FIG. 3 is a flow chart illustrating a preferred method for controlling the spectrum panel 8 according to the present invention.

When the monitor 1 and the computer are powered on, in step S20, the MCU 10 receives audio data from the computer.

In step S21, the spectrum switch 6 is ready to receive input actions.

In step S22, the MCU 20 detects whether the spectrum switch 6 activates the spectrum module 40 or deactivates the spectrum module 40. If the spectrum switch 6 activates the spectrum module 40, the procedure goes to step S23, otherwise, the procedure goes to step S27.

In step S23, the spectrum module 40 becomes activated, the spectrum module 40 obtains the audio data and generates the spectral images according to the audio data.

In step S24, spectral images are displayed on the spectrum panel 8.

In step S25, the MCU 20 judges whether the spectrum switch 601 deactivates the spectrum module 40. If the spectrum switch 6 is actuated, the procedure goes to step S26, otherwise, the procedure goes back to step S24.

In step S26, the spectrum module 40 is deactivated and stops obtaining the audio data.

In step S27, the spectrum panel 8 is powered off.

As shown in the aforementioned procedure, the screen display 2 is independent of the spectrum panel 8.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A monitor with a spectrum panel, the spectrum panel comprising:
a micro controller unit (MCU) connecting with an audio module and a spectrum module;
the spectrum module connecting with a spectrum switch and a spectrum panel;
the audio module configured for converting audio data from a computer into sound;
the spectrum module configured for converting the audio data into spectral images;
the spectrum panel configured for displaying the spectral images;
the spectrum switch configured for activating and deactivating the spectrum module and the spectrum panel
the MCU controlling an operation of the audio module and the spectrum module.

2. The monitor according to claim 1, wherein the spectrum switch and the spectrum panel is installed in the corner or halfway from the center of the frame of the monitor.

3. The monitor according to claim 2, wherein the spectrum switch activates the spectrum module and the spectrum module converts the audio data into the spectral images.

4. The monitor according to claim 3, wherein the spectral images are displayed on the spectrum panel.

5. The monitor according to claim 4, wherein the spectrum switch deactivates the spectrum module and no spectral image is displayed on the spectrum panel.
